(19) United States
(12) Patent Application Publication
(10) Pub. No.: US 2007/0223215 A1
(43) Pub. Date: Sep. 27, 2007

(54) Ear-hanging flashlight

(76) Inventor: Hung-Ke Chou, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/389,221

(22) Filed: Mar. 27, 2006

(51) Int. Cl. F21L 4/00

(52) U.S. Cl. 362/157

(57) ABSTRACT

An ear-hanging flashlight including a base, an ear-hanging portion, and a rotatable portion. This ear-hanging portion is roughly C-shaped. The rotatable portion has a second pivoting portion, a light-emitting portion, and a controller. The second pivoting portion of the rotatable portion is pivoted with said base and has at least a first position and a second position. This controller can control the light-emitting portion to emit/stop a predetermined light. It is easy and convenient to hang on. The light emitting direction is adjustable. It can light up and warn people. The flashing light is very helpful for attracting a rescue team.

### BACKGROUND OF INVENTION

1. Field of the Invention

The present invention relates to an ear-hanging flashlight. Particularly, it relates to an ear-hanging flashlight that can emit light forward or backward. In this invention, it is easy and convenient to hang on. The light emitting direction is adjustable. It can light up and warn people. The flashing light is very helpful for attracting a rescue team.

2. Description of the Prior Art

Referring to FIG. 8, it is a traditional miner's lamp. It can be used as a working lamp (such as in a mine) or can be used as a recreational lamp (such as for camping, games, etc.). However, the light only can be emitted forward.

However, it a female user needs to makeup in a dark environment, this user usually will not choose this kind of big and ugly miner's lamp as an auxiliary light source.

In addition, it is possible to wear the miner's lamp (to make the light emitting backward) for a bicycle rider. So, its light can warn the people or drivers behind this bicycle. But, it is quite heavy and its size is relatively large. And, it is not convenient to switch the emitting direction from backward to forward.

### SUMMARY OF THE INVENTION

The primary object of the present invention is to provide an ear-hanging flashlight. For a user, it is easy and convenient to hang on.

The next object of the present invention is to provide an ear-hanging flashlight. The light emitting direction is adjustable.

The other object of the present invention is to provide an ear-hanging flashlight. It has the functions of lighting up and warning people.

Another object of the present invention is to provide an ear-hanging flashlight. In which, the flashing light is very helpful for attracting a rescue team.

In order to achieve the above-mention objects, the present invention is provided. An ear-hanging flashlight comprising:

a base;

an ear-hanging portion being substantially C-shaped, one end of said ear-hanging portion being disposed with a first pivoting portion;

a rotatable portion having a second pivoting portion, a light-emitting portion, and a controller, said second pivoting portion of said rotatable portion being pivoted with said base and having at least a first position and a second position; when said rotatable portion moving to said first position, said light-emitting portion being facing a first direction; when said rotatable portion moving to said second position, said light-emitting portion being facing a second direction;

so that said controller can control said light-emitting portion to emit/stop a predetermined light, and said first direction and said second direction are spaced apart at least 90 degrees.

### BRIEF DESCRIPTION OF THE DRAWINGS

FIG. 1 is a perspective view of the present invention.

FIG. 2 is a view showing the adjustable ear-hanging portion.

FIG. 3 shows this invention's light emits forward.

FIG. 4 shows this invention's light emits backward.

FIG. 5 illustrates the adjustable light-emitting portion of the present invention.

FIG. 6 is a view showing the first application of this invention.

FIG. 7 is a view showing the second application of this invention.

FIG. 8 is a perspective view of the traditional miner's lamp.

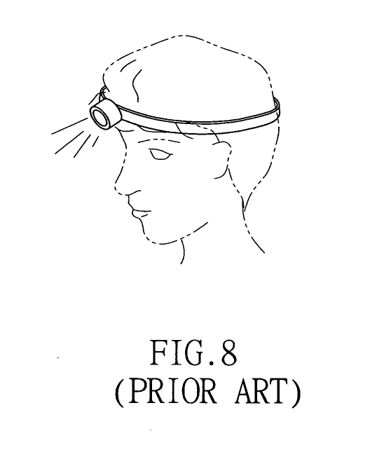

### DETAILED DESCRIPTION OF THE PREFERRED EMBODIMENT

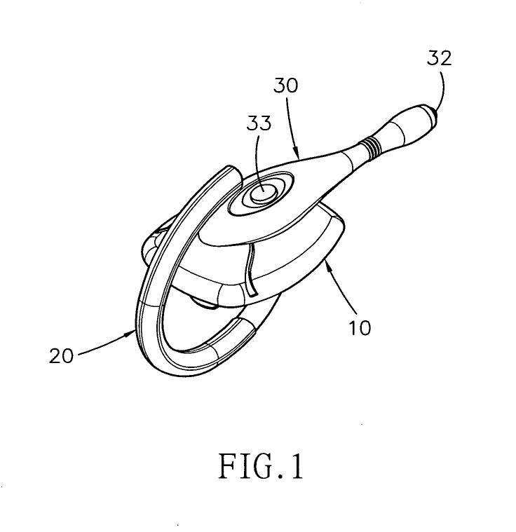

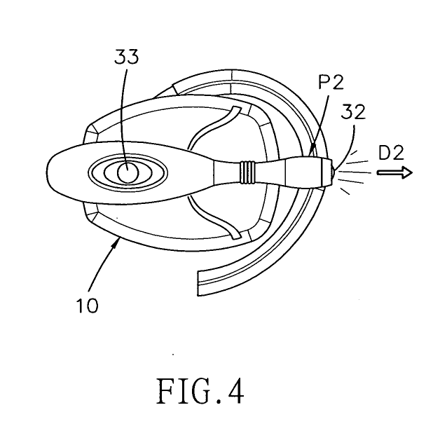

Referring to FIGS. 1 to 5, the present invention relates to an ear-hanging flashlight. It mainly comprises a base 10, an ear-hanging portion 20, and a rotatable portion 30.

About this base 10, it is a light-weighted and small-sized structure.

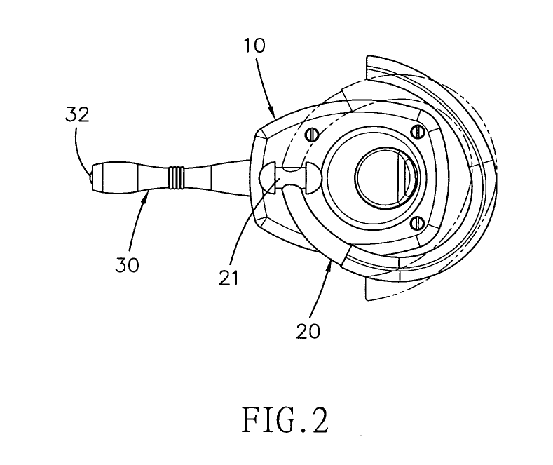

For the ear-hanging portion 20, it is substantially C-shaped. One end of the ear-hanging portion 20 is disposed with a first pivoting portion 21. So, the ear-hanging portion 20 is pivoted with the base 10 via the first pivoting portion 21. This ear-hanging portion 20 can be rotated within a range. For example, it can be rotated from the solid lines to the phantom lines shown in FIG. 2. That is, it is easy to store in some place and to adjust to most comfortable condition while hanging on a user's ear.

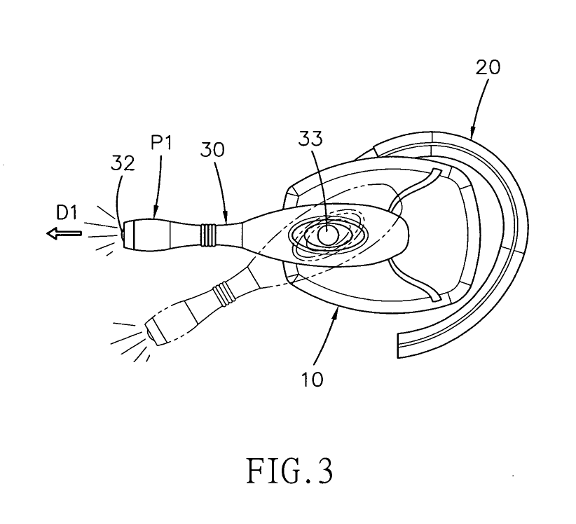

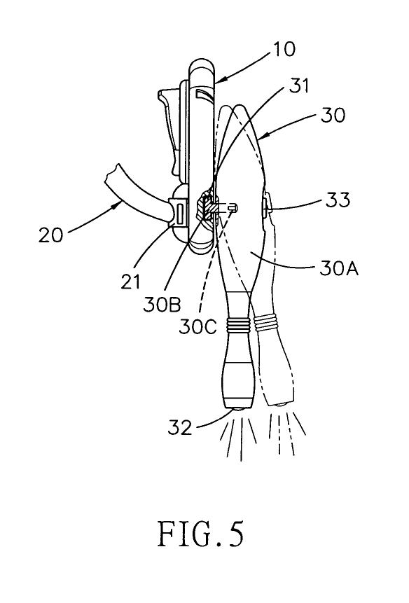

Concerning this rotatable portion 30, it has a second pivoting portion 31 (as illustrated in FIG. 5), a light-emitting portion 32, and a controller 33. The second pivoting portion 31 of the rotatable portion 30 is pivoted with the base 10 and has at least a first position P1 and a second position P2. When this rotatable portion 30 moves to the first position P1, the light-emitting portion 32 is facing a first direction D1 (such as forward). When the rotatable portion 30 moves to the second position P2, the light-emitting portion 32 is facing the second direction D2 (such as backward). Of course, when it faces forward, it still can be adjusted to face a little lower (as shown in the phantom lines in FIG. 3).

The controller 33 can control the light-emitting portion 32 to emit/stop a predetermined light. And, the first direction D1 and the second direction D2 are spaced apart at least 90 degrees.

Practically, the predetermined light can be selected from one of constant emitting, slower flashing, and faster flashing. The faster flashing is defined as flashing three to six times per second. The slower flashing is defined as flashing 0.5 to three times per second. No matter the slower flashing or the faster flashing, it creates a very excellent warning effect during night, especially to avoid the user to be hit by a vehicle behind.

With regard to the detailed structure, this rotatable portion 30 can further comprise:

(a) rotatable body 30A for mounting the light-emitting portion 32 and the controller 33;

(b) a connector 30B for mounting the second pivoting portion 31; and

(c) a third pivoting portion 30C for pivotally connecting the rotatable body 30A and the connector 30C so as to allow the rotatable body 30A to rotate with a predetermined angle.

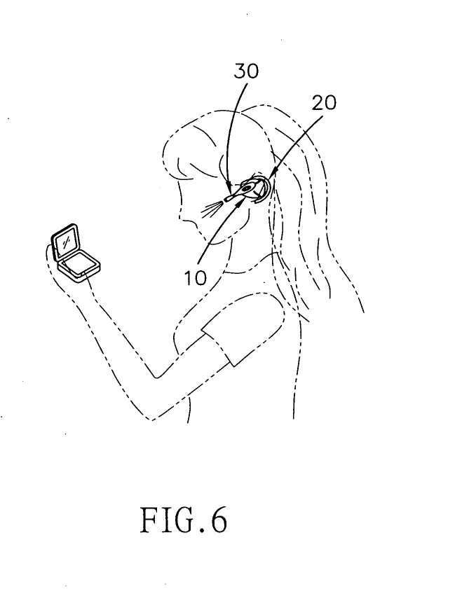

When this invention is hung on a user's ear, it can be used as a light for makeup as shown in FIG. 6. In a darker environment, this user can adjust the light-emitting direction moving forward or a little inner downward for facial makeup (such as using a lipstick, cosmetics, and so on). It is extremely convenient.

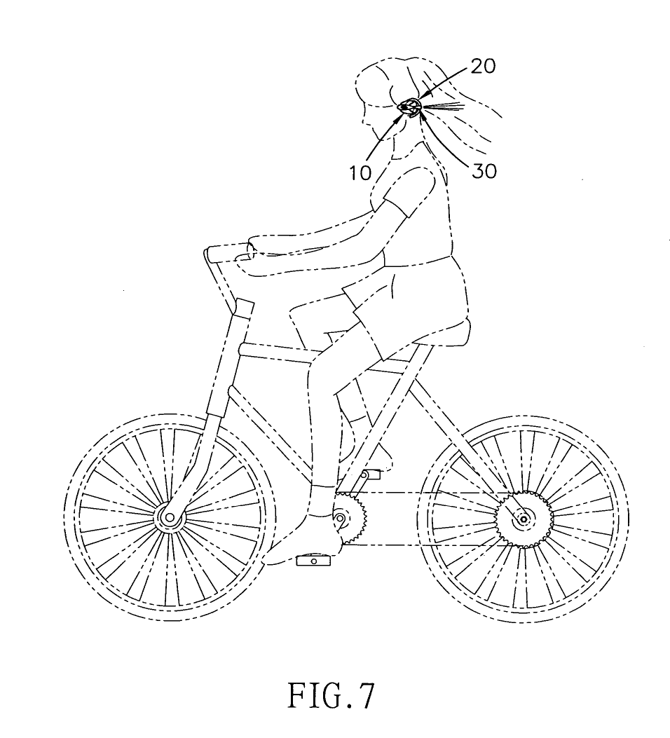

Besides, when this invention is hung on a bike rider at night, as illustrated in FIG. 7, this rotatable portion 30 can be changed to face backward. It is better to select the slow flashing or fast flashing mode, so it can create a warning signals to others (could be riders or car drivers) behind this bike. It can significantly prevent an accident. Similarly, this invention can be used on a jogger or a walker.

In addition, when a worker in a dark environment, this ear-hanging type invention will not influence both hands of the user at work.

Furthermore, in case a camper or a mountain climber is lost, this invention can emit a flashing signal. Such flashing signal at night is very helpful to be found by a rescuer (or a rescue team). Thus, the possibility to be rescue can be highly raised.

The advantages and functions of this invention can be summarized as follows:

[1] It is easy and convenient to hang on. By using this invention's ear-hanging portion, this invention can be easily hung on one ear (either the right ear, the left ear; or both ears if using two) of the user. It is very easy and convenient to hang on.

[2] The light emitting direction is adjustable. By rotating the rotatable portion of this invention, the light emitting direction can be forward or backward. If a third pivoting direction is applied, it also can be adjusted to slightly inward or outward. Thus, the light-emitting direction can be arbitrarily adjusted to a desired condition.

[3] It can light up and warn people. This invention can be used as a make-up lamp, auxiliary working lamp, or a jogger or bicycle rider's warning lamp (for warning people behind). It has multiple functions.

[4] The flashing light is very helpful for attracting a rescue team. In case a camper or a mountain climber is lost, this invention can emit a flashing signal at night. Such flashing signal (similar to the flashing signal on an airplane's wing) at night is very helpful to be found by the rescuer. Thus, the possibility to be rescue can be highly raised.

The above embodiments are only used to illustrate the present invention, not intended to limit the scope thereof. Many modifications of the above embodiments can be made without departing from the spirit of the present invention.

What is claimed is:

1. An ear-hanging flashlight comprising:
a base;
an ear-hanging portion being substantially C-shaped, one end of said ear-hanging portion being disposed with a first pivoting portion;
a rotatable portion having a second pivoting portion, a light-emitting portion, and a controller, said second pivoting portion of said rotatable portion being pivoted with said base and having at least a first position and a second position; when said rotatable portion moving to said first position, said light-emitting portion being facing a first direction; when said rotatable portion moving to said second position, said light-emitting portion being facing a second direction;
so that said controller can control said light-emitting portion to emit/stop a predetermined light, and said first direction and said second direction are spaced apart at least 90 degrees.

2. The ear-hanging flashlight as claimed in claim 1, wherein said predetermined light is selected from one of constant emitting, slower flashing, and faster flashing; said faster flashing is defined as flashing three to six times per second; and, said slower flashing is defined as flashing 0.5 to three times per second.

3. The ear-hanging flashlight as claimed in claim 1, said rotatable portion further including:
rotatable body for mounting said light-emitting portion and said controller;
a connector for mounting said second pivoting portion; and
a third pivoting portion for pivotally connecting said rotatable body and said connector so as to allow said rotatable body to rotate with a predetermined angle.
